(19) United States
(12) Patent Application Publication
(10) Pub. No.: US 2016/0129789 A1
(43) Pub. Date: May 12, 2016

(54) Vehicle Distributed Network

(71) Applicant: Jaguar Land Rover Limited, Coventry (GB)

(72) Inventors: Simon Halford, Coventry (GB); Karl Barker, Coventry (GB)

(21) Appl. No.: 14/900,512

(22) PCT Filed: Jul. 30, 2014
(86) PCT No.: PCT/EP2014/066419

§ 371 Date: Dec. 21, 2015

(30) Foreign Application Priority Data
Jul. 30, 2013 (GB) 1313626.2

(51) Int. Cl. B60K 37/02; B60R 16/023; B60R 1/00

(52) U.S. Cl. CPC B60K 37/02; B60R 1/00; B60R 16/0238; B60R 2300/804

(57) ABSTRACT

A vehicle distributed network subsystem (20; 30; 50; 60; 70; 80; 90; 100) for providing feedback to a user comprises a plurality of electronic control units (ECUs) each having an associated processor or signal conditioning device such as a filter or a gate. Two or more human-to-machine interfacing terminals provide feedback to the driver. The ECUs can communicate with one another and with said terminals over a data transmission means (6; 13; 39; 101). The data transmission means is configured to receive data from at least one data source. The subsystem is configured to define a nominated ECU (10; 32; 72) for generating processed data from data received from said data transmission means, and the subsystem is configured to deliver said processed data to each of said terminals for consistent output to the user.

### TECHNICAL FIELD

The present disclosure relates to a vehicle distributed network subsystem for providing feedback to a user. In particular, but not exclusively, aspects of the present invention relate to a vehicle distributed network subsystem for providing feedback to an occupant of the vehicle, such as a driver or a passenger. Aspects of the invention also relate to a vehicle driver information system; a vehicle wade sensing system; a vehicle eco-driving system; a vehicle lane departure system; a vehicle distributed network system; a vehicle; a method; and a distributed computer program product.

### BACKGROUND OF THE INVENTION

Modern vehicles can be equipped with multiple internal displays for providing information to the driver. Various parameters can be displayed on each display, for example instantaneous vehicle speed and fuel consumption. There is a requirement to display a parameter simultaneously on different displays. Telematics allows said parameters to be additionally simultaneously displayed, for example, on one or more smartphone displays.

Typically, the displayed parameter depends on vehicle usage and/or external conditions, and is therefore subject to variation in time. Raw data are collected by one or more vehicle sensor and are then processed by a vehicle system. Typically, the vehicle system is configured to dynamically compute the to-be-displayed parameter. The results of such computations are transmitted to the displays and thus outputted to the driver.

Modern vehicles typically comprise distributed networks having a plurality of interconnected electronic control units/modules (ECUs). Each ECU is configured to perform certain functions and may incorporate a number of sensors and/or actuators. Examples of ECUs are: the engine control module (ECM); the transmission control module (TCM); the audio control module (ACM); the body control module (BCM); the anti-lock braking control module (ABS); the cruise control module (CCM); the electric power steering control module (EPSCM); and the sun roof control module (SCM). Each ECU comprises one or more network interfaces and at least one processor or other signal processing/conditioning device (such as a filter, or a gate). Modern systems can incorporate tens of ECUs, or even one hundred or more ECUs.

It is possible to identify network subsystems. Each network subsystem comprises a group or cluster of ECUs which collaborate over the network infrastructure to deliver a higher level functionality. Thus the displays may be part of a driver information subsystem and may be part of different ECUs. Accordingly, if the first and second displays are required to simultaneously output a given parameter, there is a risk that the outputted values might be discrepant. This can happen for essentially three reasons: because the outputted values have been calculated by different ECUs; because the calculations have been performed on different sets of source data/signals; or because there is a varying latency between the first and the second display. Any such discrepancy may affect user confidence in the displayed information.

U.S. Pat. No. 6,505,100 discloses a distributed vehicle information processing and vehicle control system having a first subsystem located onboard of the vehicle and a second subsystem, located at a separate location, in communication with the first subsystem by means of a data transmission network. The architecture of the distributed vehicle information processing and vehicle control system is formed completely from components which follow a standard architecture specification for joining them together to form the overall system. The document discloses information being provided to the driver only via a voice output while driving, or only via a visual display when the vehicle is stationary, in order to reduce distraction.

It is against this background that the present invention has been conceived. At least in certain embodiments, the present invention seeks to reduce the risk of, or to prevent, a vehicle occupant being subjected to discrepant or contrasting information received simultaneously from different human-to-machine terminals (also known as human-to-machine interfaces). At least in certain embodiments, the present invention seeks to address shortcomings associated with the prior art or to improve parts, apparatus, systems and methods disclosed in the prior art.

### SUMMARY OF THE INVENTION

Aspects of the present invention relate to a vehicle distributed network subsystem for providing feedback to a user; to a vehicle driver information system; to a vehicle wade sensing system; to a vehicle eco-driving system; to a vehicle lane departure warning system; to a vehicle distributed network; to a vehicle; to a method; and to a distributed computer program product.

According to an aspect of the invention, there is provided a vehicle distributed network subsystem for providing feedback to a user, the subsystem comprising:
a plurality of electronic control units (ECUs); and
a data transmission means over which said ECUs can communicate with one another, the data transmission means being configured to receive data from at least one data source;
wherein the subsystem is configured to define a nominated ECU for generating processed data from the data received from said data transmission means, and
wherein the subsystem is configured to broadcast said processed data for delivery to two or more terminals for providing feedback to the user.

The processed data can be broadcast over the same or a different data transmission means.

The subsystem can comprise two or more terminals. The two or more terminals can be configured to communicate with said ECUs over the data transmission means.

Each of said ECUs can have at least one associated processor or other signal/data conditioning device (e.g. a filter, or a gate). Some ECUs may have a signal/data conditioning device in addition to a processor.

It will be appreciated that the terms signal and data are used herein interchangeably. The term message can also be used instead of signal or data.

With a subsystem architecture according to an aspect of the invention, the possibility that values of a same parameter communicated directly or indirectly to the user by means of different terminals be different is reduced, minimised or eliminated.

One or more terminals can be configured to present, or otherwise communicate, said values directly to the user according to a predetermined numeric format. Examples of suitable terminals are displays or loudspeakers. One or more terminals can be configured to communicate said values indirectly, for example by transforming said values into warning events such as a visual alarm (e.g. a flashing red light), an aural alarm (e.g. a buzzing sound) or a haptic feedback (e.g. vibration of the steering wheel).

Furthermore, with a subsystem architecture in accordance with the invention, a certain calculation is prevented from being performed redundantly in the system, i.e. is prevented from being performed multiple times by different processors belonging to different ECUs. The calculation is performed only by a single, nominated ECU. Since any requirements to perform the calculation multiple times are avoided, the subsystem architecture is computationally efficient as computational resources are freed up for other applications or the computational energy consumption is reduced. Furthermore, should the calculation algorithm need to be changed, it will be necessary to reprogram or update with a new software only one ECU. Further still, any calibration file differences between different vehicle distributed networks serving different vehicles need only exist in a single ECU.

The data transmission means can comprise one or more data transmission bus. For example, the data transmission means can comprise a controller area network (CAN) bus. However, other bus types are possible such as local interconnect network (LIN) bus, media oriented systems transport (MOST) bus, Ethernet bus, Broad Reach bus or Flexray bus. The data transmission means can comprise a wi-fi data transmission network (WLAN), or a Bluetooth data transmission network. The data transmission means could comprise a SAE J1939 bus.

In some embodiments, the subsystem can be configured to deliver said processed data to each of said terminals for simultaneous or at least substantially simultaneous output to the user. The user may have an even greater expectation that the values presented by the system be substantially similar or equal, or that any corresponding warning events be triggered simultaneously. In some embodiments, different terminals and/or ECUs can be programmed to associate different data latencies to the processed data. Each of the data latencies can be below a predetermined value. Said predetermined value can be, for example, 200 ms, or 100 ms. Two or more of said data latencies can be equivalent, or, to use a different term, aligned.

In some embodiments, the terminals can be configured to output feedback to a vehicle occupant, such as a driver or a passenger. In some embodiments, the terminals can be configured to output feedback to the driver of the vehicle. In other embodiments, the terminals can be one or more remote terminals, such as smartphones or smartphone displays. In some embodiments, the remote terminals can be configured to output feedback to a remote user and/or configured to communicate with one or more telemetry units installed in the vehicle. It will be understood that “remote user” means a user remote from the vehicle.

In some embodiments, the data transmission means can be configured to receive data relating to an operating parameter of the vehicle such as vehicle speed. In other embodiments, the data transmission means can be configured to receive data relating to external vehicle conditions, such as external temperature. Some of these data can be supplied to the data transmission means by another, separate vehicle distributed network subsystem present on the vehicle, or directly by means of one or more sensors installed in the vehicle.

In some embodiments, each of said terminals can be part of a respective user interface ECU—here the wording user interface ECU is used to denote an ECU which comprises at least one terminal for human-to-machine interfacing. A first of these ECUs can subscribe to a second of these ECUs. Such a subscription can be configured such that messages exchanged between said ECUs have minimal latency, i.e. high priority. Otherwise, a first and a second of these ECUs can each subscribe to a third ECU. Said third ECU can be the nominated ECU. Several processors configured to process data in parallel can be provided in the nominated ECU, or a single processor or other data conditioning device such as a filter, or a gate, can be provided in the nominated ECU. It will be understood that the wording “processed data” as used herein can also encompass filtered and/or gated data.

According to another aspect of the invention, there is provided a vehicle driver information system comprising a vehicle distributed network subsystem as described herein, wherein the data transmission means is configured to receive data from at least one of the following ECUs:
a powertrain control module (PCM);
a cruise control module (CCM);
a transmission control module (TCM);
a transfer case control module (TCCM);
an antilock braking system module (ABS); or
a parking aid module (PAM),

wherein an instrument panel cluster (IPC) ECU is configured to function as the nominated ECU, and wherein each of the terminals is a display. The vehicle driver information system can be configured to provide data relating to vehicle or engine speed, instantaneous fuel consumption etc.

One of the displays could be the display of the IPC ECU (the IPC ECU is responsible for the provision of information to the driver on a screen located on the main vehicle instrumentation board). One of the displays could be part of a head-up display (HUD) ECU (the HUD ECU is responsible for the provision of information to the driver on a screen located at a location visible by the driver as the driver looks at the road).

In some embodiments, the data transmission means is configured to receive data relating to vehicle or engine speed, the nominated ECU is configured to generate processed data relating to vehicle or engine speed, and the displays are each configured to visualise said processed data.

According to another aspect of the invention, there is provided a vehicle wade sensing system comprising a vehicle distributed network subsystem as described herein and comprising a further data transmission means and a gateway ECU for distributing data between the data transmission means, wherein at least one of said means is configured to receive data from at least one of the following:
an anti-lock braking system (ABS) ECU;
a parking aid module (PAMB);
a forward or rearward park assist sensor;
a water presence sensor;
a water depth sensor; or
a chassis control module (CHCM);

wherein the PAMB is configured to function as the nominated ECU, and

wherein each of the terminals is a display.

The parking aid module can comprise downward sensors for detecting water presence and/or water level.

One of the displays could be part of an instrument panel cluster ECU (IPC ECU). Another of the displays could be part of a front control display interface module ECU (FCDIM ECU) (an FCDIM ECU is responsible for the display of information on a touch screen located on the dashboard of the vehicle).

In some embodiments, at least one of the means is configured to receive data relating to the level of water surrounding the vehicle, the nominated ECU is configured to generate processed data relating to said water level, and the displays are each configured to visualise said processed data.

According to another aspect, the invention provides a vehicle eco-driving system comprising a vehicle distributed network subsystem as described herein and comprising a further data transmission means and a gateway module (GWM) ECU for distributing data between the data transmission means;

wherein at least one of said means is configured to receive data relating to fuel consumption, wherein an instrument panel cluster (IPC) ECU is configured to function as the nominated ECU, and wherein each of the terminals is a display.

One of the displays could be part of the IPC ECU. Another of the displays could be part of a front control display interface module ECU (FCDIM ECU). Another of the displays could be part of a smartphone or of a remote computer. Other human-to-machine interfaces can be used on onboard or remote devices, such as a haptic feedback means.

In some embodiments, the nominated ECU is configured to generate processed data relating to fuel consumption, and the displays are each configured to visualise a signal for encouraging eco driving based on said processed data.

According to a further aspect of the invention, there is provided a vehicle lane departure warning system comprising a vehicle distributed network subsystem as described herein and comprising a further data transmission means and a gateway module (GWM) ECU for distributing data between the data transmission means, wherein at least one of said data transmission means is configured to receive data relating to relative positioning of the vehicle in a lane, wherein the GWM ECU is configured to function as the nominated ECU, and wherein at least one of the terminals is a display.

The display could be part of an instrument panel cluster (IPC) ECU. At least one of the terminals could be a haptic feedback terminal for providing haptic feedback to a vehicle driver. In some embodiments, the haptic feedback terminal is part of a power steering control module (PSCM) ECU.

In some embodiments, at least one of said data transmission means is configured to receive data from a vehicle camera.

According to yet a further aspect of the invention, there is provided a vehicle distributed network comprising a vehicle distributed network subsystem as described herein, and/or a vehicle driver information system as described herein, and/or a vehicle wade sensing system as described herein, and/or a vehicle eco driving system as described herein, and/or a vehicle lane departure warning system as described herein.

According to yet a further aspect of the invention, there is provided a vehicle comprising a vehicle distributed network as described herein.

According to yet a further aspect of the invention, there is provided a method of providing feedback to a user of a vehicle via a plurality of terminals connected to a vehicle distributed network, the method comprising:
supplying data to a data transmission means serving a plurality of electronic control units (ECUs);
processing said data by means of a nominated ECU in order to generate a set of processed data; and
broadcasting the processed data for delivery to two or more of said terminals for output to the user.

In some embodiments, the method can further comprise delivering the processed data to two or more of said terminals for output to the user.

According to yet a further aspect of the invention, there is provided a distributed computer program product for configuring a vehicle distributed network, the distributed computer program product comprising a computer readable storage medium including computer readable program code, where the computer readable program code when executed on a vehicle system comprising a vehicle distributed network having a plurality of terminals for human-to-machine interfacing configures the vehicle distributed network such that a vehicle distributed network subsystem and/or a vehicle driver information system and/or a vehicle wade sensing system and/or a vehicle eco-driving system and/or a vehicle lane departure warning system and/or a vehicle as described herein can be identified.

According to yet a further aspect of the invention, there is provided a distributed computer program product comprising a computer readable storage medium including computer readable program code, where the computer readable program code when executed on a vehicle system comprising a vehicle distributed network having a plurality of terminals for human-to-machine interfacing configures the vehicle distributed network for performing the method(s) described herein.

The nominated ECU can be selected based on one or more criterion. In some embodiments, the nominated ECU is the ECU having the largest and/or fastest processing capability. In some embodiments, the nominated ECU is an ECU having spare processing capability. In some embodiments, the nominated ECU is nominated based on direct accessibility by the terminals over a common data transmission means. Alternatively, the nominated ECU can be accessed indirectly by the terminals, i.e. the nominated ECU can be accessed from different and/or separate data transmission means, each communicating directly with one of the terminals.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

An embodiment of the present invention will now be described, by way of example only, with reference to the accompanying figures, in which:

FIG. 1 contains explanatory notes for interpreting FIGS. 2, 3 and 4;

FIG. 2 is a system architecture diagram according to the prior art showing a driver information subsystem for outputting information to the driver on two displays;

FIG. 3 is a system architecture diagram showing a driver information system according to an embodiment of the present invention;

FIG. 4 is a system architecture diagram showing a wade sensing system according to another embodiment of the present invention;

FIG. 5 is a system architecture topology diagram showing an eco-driving system according to another embodiment of the present invention;

FIG. 6 is a system architecture topology diagram representing schematically the data flow between certain ECUs of the subsystem of FIG. 5;

FIG. 7 is a system architecture topology diagram equivalent to that shown in FIG. 5, with the data flow represented in an alternative manner compared to FIG. 6;

FIG. 8 is a system architecture topology diagram representing a system architecture in accordance with another embodiment of the present invention, showing the data flow between certain ECUs;

FIG. 9 is a system architecture topology diagram equivalent to that shown in FIG. 8, with the data flow represented in an alternative manner compared to that of FIG. 8;

FIG. 10 is a system architecture topology diagram representing schematically the data flow between certain ECUs forming part of a lane departure warning system in accordance with another embodiment of the invention;

FIG. 11 is a system architecture topology diagram representing schematically the data flow between certain ECUs forming part of a lane departure warning system in accordance with another embodiment of the present invention;

FIG. 12 is a system architecture topology diagram representing schematically the data flow between certain ECUs forming part of a lane departure warning system which is in accordance with another embodiment of present invention; and

FIG. 13 is a system architecture topology diagram representing schematically the data flow between certain ECUs forming part of a lane departure warning system in accordance with another embodiment of the present invention.

### DETAILED DESCRIPTION OF AN EMBODIMENT

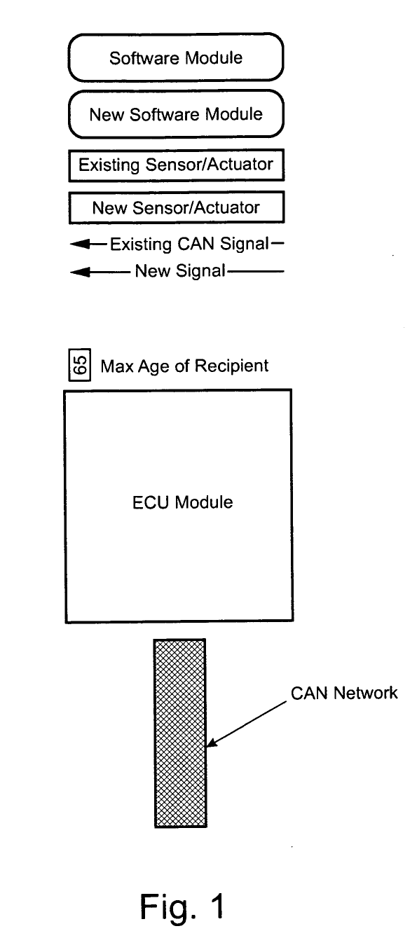

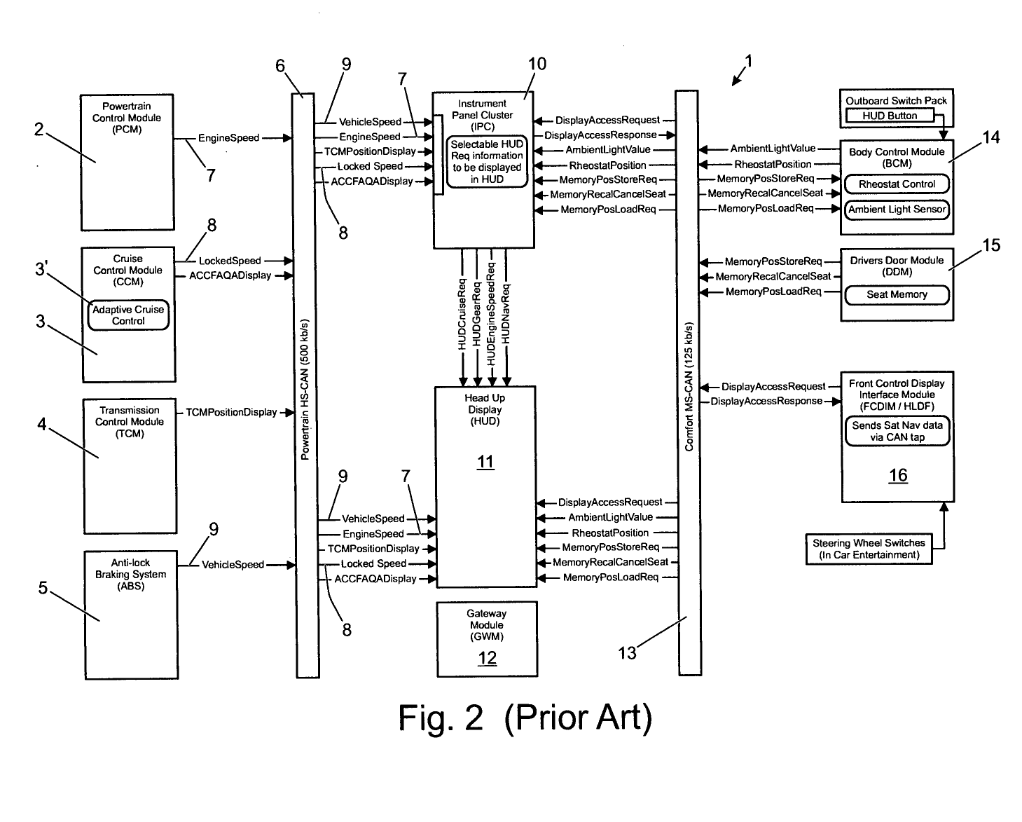

FIG. 1 provides explanatory notes for the interpretation of FIGS. 2, 3 and 4: horizontal boxes with rounded corners represent software modules; horizontal shade-filled boxes with right angle corners represent sensors or actuators; arrows represent signals/data published by the various electronic control units (ECUs) on the network, or supplied by the network to the various ECUs; small vertical boxes represent values related to signal latencies imposed by a network interface of an ECU; large boxes with right angle corners represent ECUs and elongated shade-filled vertical boxes represent data transmission network buses.

FIG. 2 shows schematically a driver information subsystem 1 according to a network architecture which allows simultaneous display to the driver of selected vehicle operating parameters on two displays. This network architecture is not an embodiment of the invention, and is herein described purely to help the skilled person to appreciate the features of the invention, which will be introduced later.

The subsystem 1 comprises: a powertrain control module (PCM) 2; a cruise control module (CCM) 3; a transmission control module (TCM) 4; and an anti-lock braking system (ABS) 5. The PCM 2, CCM 3, TCM 4 and ABS 5 are connected to a powertrain high speed controller area network (PT-CAN) bus 6. The PCM 2 is configured to publish an engine speed signal 7 on the PT-CAN bus 6. The CCM 3, which hosts an adaptive cruise control software package 3′, is configured to publish a locked speed signal 8 on the PT-CAN bus 6. The ABS 5 is configured to publish a vehicle speed signal 9 on the PT-CAN bus 6.

An instrument panel cluster (IPC) ECU 10 and a head-up display (HUD) ECU 11 subscribe to the PT-CAN bus 6 so that the engine speed signal 7, the locked speed signal 8 and the vehicle speed signal 9 are supplied to each of the IPC and HUD ECUs 10, 11. The IPC and HUD ECUs 10, 11 are each equipped with a processor (not shown) and a network interface (not shown). The network interfaces of the IPC and HUD ECUs are configured to assign different priorities (or ‘latencies’) to the locked speed, engine speed and vehicle speed signals 7, 8, 9. The signal latencies also depend on the level of usage of the PT-CAN bus 6 and thus cannot be robustly predicted. It is only possible to reliably estimate a worst case scenario latency.

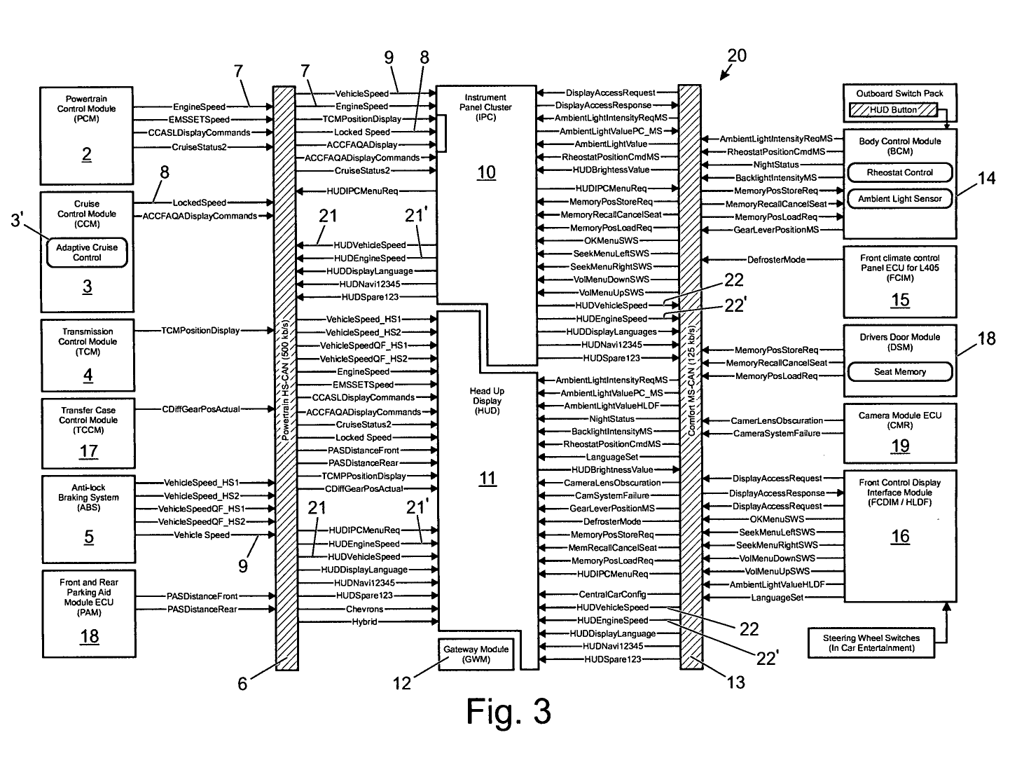

The IPC and HUD ECUs have separate processors. A first display is provided on the vehicle main instrument board (not shown) and is part of the IPC ECU. A second display is provided elsewhere on a position that can be seen by the driver while the driver looks at the road, and is part of the HUD ECU 11. The IPC ECU 10 and the HUD ECU 11 are thus configured within the subsystem such that each will independently process the locked speed, engine speed and vehicle speed signals 7, 8, 9 in order to produce corresponding independent displays of values related to said signals 7, 8, 9 on each of the first and second displays. Since the processors of the IPC and HUD ECUs are different, the displayed values on the primary and secondary screens may be different. This may result in a lack of confidence by the driver in the displayed values. If the processors were the same (or very similar) there would still be a risk that different sets of source data are processed and then outputted on the displays because each of the IPC and HUD ECUs 10, 11 independently subscribe to the PT-CAN bus 6 for data input. Due to potentially different message latencies, the display of the IPC ECU 10 could be displaying, for example, a value of vehicle speed calculated from source data measured by a sensor of the ABS module 5 at a time instant t-1, and the display of the HUD ECU 11 could be displaying a value of vehicle speed calculated from resampled source data, i.e. from data measured by the ABS sensor at a time instant t-2 greater than t-1. On the other hand, the subsystem illustrated in FIG. 3 minimises or prevents the risk of inconsistent values being displayed at the same time on the IPC and HUD displays.

The vehicle driver information subsystem 1 of FIG. 2 also comprises a further data transmission bus 13, which is a comfort medium speed controller area network (CO-CAN) bus 13. The CO-CAN 13 is configured to receive signals published on the network by a body control module (BCM) 14, a driver's door control module (DDM) 15, and a front control display interface module (FCDIM) 16. The subsystem 1 thus also comprises a gateway module (GWM) ECU 12 which is responsible for the distribution of signals between the different data transmission buses 6, 13. The functionalities of these modules are not described here in further detail as they are not immediately relevant to the invention.

### Driver Information System

FIG. 3 shows schematically a driver information system 20 which allows simultaneous display of selected vehicle operating parameters on two displays. This system 20 is according to an embodiment of the invention. Like reference numerals have been used to indicate features or components equivalent to features or components shown in FIG. 2.

The subsystem 20 comprises: a powertrain control module (PCM) 2; a cruise control module (CCM) 3; a transmission control module (TCM) 4; an anti-lock braking system (ABS) 5; a transfer case control module (TCCM) 17; and a front and rear parking aid module (PAM) 18. The PCM 2, CCM 3, TCM 4; ABS 5; TCCM 17; and PAM 18 interface on a powertrain high speed controller area network (PT-CAN) bus 6. The PCM 2 is configured to publish an engine speed signal 7 on the PT-CAN bus 6. The CCM 3, which hosts an adaptive cruise control software package 3′, is configured to publish a locked speed signal 8 on the PT-CAN bus 6.

An instrument panel cluster (IPC) ECU 10 and a head up display (HUD) ECU 11 subscribe to the PT-CAN bus 6. In this embodiment, the engine speed, locked speed and vehicle speed signals 7, 8, 9 are passed only to the IPC ECU 10. The IPC and HUD ECUs 10, 11 are each equipped with a respective processor (not shown) and a network interface (not shown). The network interfaces of the IPC and HUD ECUs are configured to assign different priorities (or ‘latencies’) to the engine speed, locked speed, and vehicle speed signals 7, 8, 9. It should be noted, however, that in this embodiment the IPC ECU 10 and the HUD ECU 11 do not subscribe to the same signals on the PT-CAN bus 6, and therefore the presence of different latencies in these signals will be irrelevant. In other words, the HUD ECU 11 is a complete slave of the IPC ECU 10. As a result, the displays will output matching results with just a small lag due to the master/salve relationship between the HUD ECU 11 and the IPC ECU 10.

A first display is provided on the vehicle instruments board (not shown) and is part of the IPC ECU 10. A second display (not shown) is located elsewhere in a position designed to be seen by the driver while the driver looks at the road, and is part of the HUD ECU 11. The IPC ECU 10 processes the engine speed, locked speed and vehicle speed signals 7, 8, 9. The corresponding processed signals generated by the IPC ECU 10 are: an HUD vehicle speed signal 21; an HUD engine speed signal 21′. The HUD vehicle and engine speed signals 21, 21′ are published by the IPC ECU 10 on the PT-CAN bus 6. The HUD ECU 11 subscribes to the HUD vehicle and engine speed signals 21, 21′ via the PT-CAN bus 6. Accordingly, the primary and secondary displays will now output to the driver consistent values related to the engine speed, locked speed and vehicle speed signals 7, 8, 9 on each of the first and second displays. This is possible essentially for two reasons: first, the subsystem 20 is now configured to centrally process the relevant data at the IPC ECU 10; second, the latency of the to-be-displayed signals with respect to the HUD ECU subscription on the PT-CAN network bus 6 is negligible, whereby even at high levels of usage of the PT-CAN bus 6, the display of the HUD ECU will reliably receive the to-be-displayed data for substantially simultaneous output with the display of the IPC ECU. Any lag can be kept below a perception speed, for example below 50 ms.

Consistent display of values on the IPC ECU's display on the one hand and on the HUD ECU's display on the other hand may affect driver confidence in the displayed information. There is no risk that different sets of source data be independently processed for output by each of the IPC and HUD ECUs 10, 11 since these ECUs do not independently subscribe, filter and process to the PT-CAN bus 6 for data input. This is in contrast with the network architecture illustrated in FIG. 2.

A comfort medium speed CAN (CO-CAN) bus 13 is in addition configured to receive signals published on the network by a body control module (BCM) 14, a driver's door control module (DDM) 15, a front control display interface module (FCDIM) 16; a driver's seat module (DSM) 18, and a camera module (CMR) 19. The functionalities of these modules are not described herein in further detail since not immediately relevant to the invention. As for the subsystem shown in FIG. 2, the subsystem 20 of FIG. 3 also comprises a gateway module (GWM) ECU 12 which is responsible for the distribution of signals between the different data transmission buses 6, 13.

### Wade Sensing System

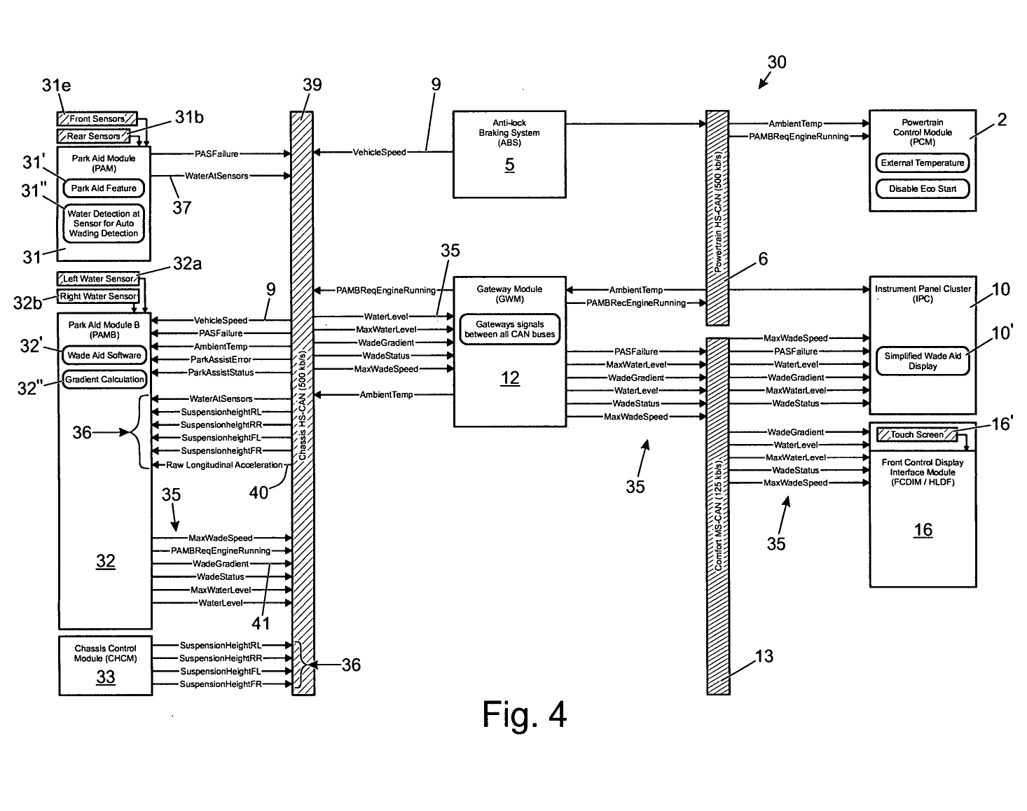

FIG. 4 shows schematically the network architecture of a wade sensing system 30 according to an embodiment of the invention which allows simultaneous display to the driver of selected vehicle operating parameters on two displays in accordance with an embodiment of the invention. Like reference numerals have been used to indicate features or components equivalent to features or components shown in FIG. 2 and/or 3.

The subsystem 30 comprises: a front and rear park aid module (PAM) 31; a left and right park aid module (PAMB) 32, a chassis control module (CHCM) 33 and an ABS module 5. The PAMB comprises left and right water level sensors 32a, 32b pointed downwards for detecting presence of water and/or for assessing water depth. The PAM comprises a park aid feature software package 31′ and a water detection software package 31″. The PAM 31 is configured to accept input from front and rear parking sensors 31a, 31b. The PAMB 32 comprises a wade sensing software package 32′, a gradient calculation software package 32″ and is configured to accept input from the left and right water level sensors 32a, 32b. The PAM 31, PAMB 32, CHCM 33 and ABS 5 are connected to a chassis high speed controller area network (CH-CAN) bus 39. The ABS 5 is configured to publish a vehicle speed signal 9 on the CH-CAN bus 39. The CHCM 33 is configured to publish a suspension height bundle of signals 36 on the CH-CAN bus 39. The PAM 31 is configured to publish a water detection signal 37 on the CH-CAN bus 39. The PAMB 32 is configured to subscribe to the vehicle speed signal 9 and to the suspension height bundle of signals 36 from the CH-CAN bus 39. The PAMB 32 is also configured to generate a set of wade processed data signals 35 and to publish the same on the CH-CAN bus 39.

The subsystem 30 also comprises a powertrain high speed CAN (PT-CAN) 6 and a comfort medium speed CAN (CO-CAN) 13. A gateway module (GWM) ECU 12 subscribes to the wade processed data signals 35 from the CH-CAN bus 39 and distributes them to the CO-CAN 13. The PT-CAN 6 accepts signals published by the PCM 2, ABS 5 and GWM ECU 12, and makes the same available to the PCM 2, the GWM ECU 12 and an instrument panel cluster (IPC) ECU 10. The IPC ECU 10 subscribes to the wade processed data signals 35 over the CO-CAN bus 13. The IPC ECU comprises a simplified wade sensing display 10′. The wade processed data signals 35 are displayed on the simplified display 10′. The subsystem 30 also comprises a front control display interface module (FCDIM) ECU 16. The FCDIM ECU 16 comprises a touch screen 16′ for outputting information to the driver. The FDCIM ECU 16 subscribes to the wade processed data signals 35 over the CO-CAN bus 13. The wade processed data signals 35 are displayed also on the touch screen 16′. In this embodiment, the processed wade data signals 35 are generated only by a single ECU, the PAMB ECU 32 and then simultaneously displayed on the simplified wade sensing display 10′ and on the touch screen 16′ of the FDCIM ECU 16.

Even though the processors of the IPC and FDCIM ECUs 10, 16 are different, the displayed values on the simplified wade sensing display 10′ and on the FDCIM ECU touch screen 16′ are consistent. This may affect the driver confidence in the displayed values. There is no risk that different sets of source data be processed for output by each of the IPC and FDCIM ECUs 10, 16 as these ECUs are not required to perform data processing.

The PAMB ECU 32 subscribes to a Raw Longitudinal Acceleration signal 40 and publishes the result of a calculation based on said Raw Longitudinal Acceleration signal 40 as a Wade Gradient signal 41. The PAMB ECU 32 does not require the Wade Gradient signal 41 to perform its function, but the PAMB ECU 32 performs this calculation to maintain alignment of the two displays. The raw acceleration data 40 requires significant processing and filtering to robustly calculate a gradient. The PAMB ECU 32 does not require the gradient information for its own functionality but nevertheless hosts this calculation so that the multiple displays 10′, 16′ can show aligned information to the driver.

### Eco-driving System

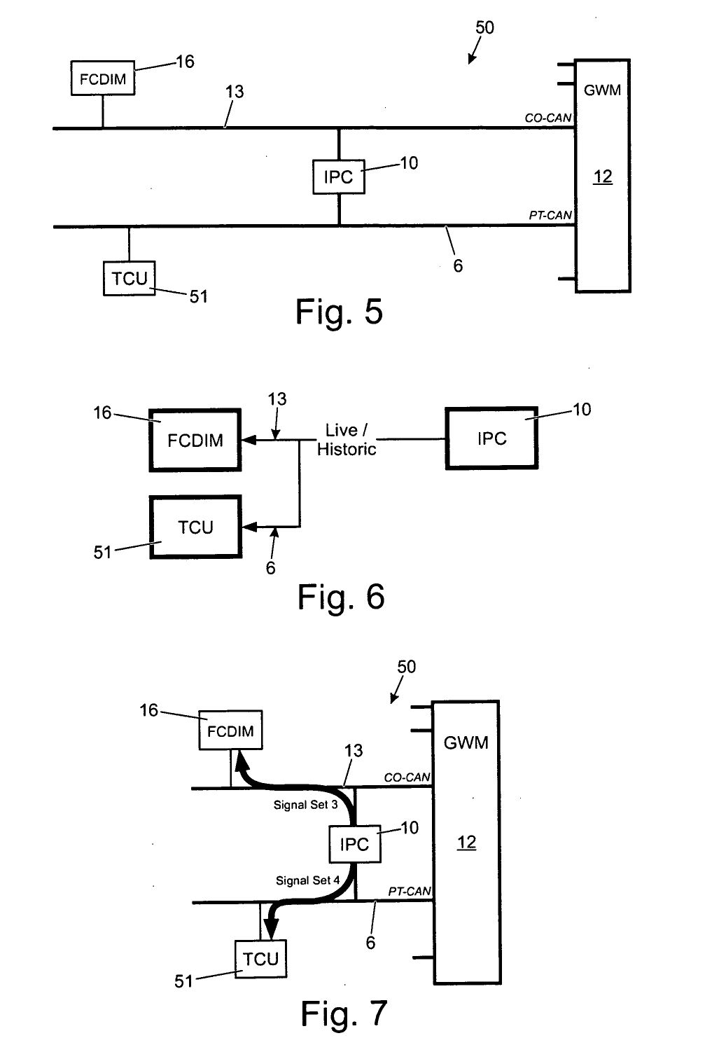

The network architecture of an eco-driving system 50 in accordance with an embodiment of the present invention will now be described, in simplified terms, in connection with FIGS. 5 to 7. Like reference numerals have been used to indicate features or components equivalent to features or components shown in FIG. 2, 3 and/or 4.

FIG. 5 shows an eco-driving system 50 comprising a gateway module (GWM) ECU 12, a comfort medium speed data transmission controller area network (CO-CAN) bus 13, a powertrain high speed data transmission controller area network (PT-CAN) bus 6, a FCDIM ECU 16, a telemetry control unit (TCU) ECU 51 and an IPC ECU 10.

The GMW ECU 12 is configured to distribute data between the CO-CAN bus 13 and the PT-CAN bus 6. The IPC ECU 10 subscribes to both the CO-CAN bus 13 and the PT-CAN bus 6. As shown in FIG. 6, the CO-CAN bus 13 is used for data exchange between the IPC ECU 10 to the FCDIM ECU 16. PT-CAN bus 13 is used to exchange data between the IPC ECU 10 to the TCU ECU 51. The IPC ECU 10 represents in this arrangement the nominated ECU and is therefore configured to receive data relating to fuel consumption from the GWM ECU 12. These data are centrally processed by the IPC ECU 10. FIG. 7 shows the flow of processed data from the IPC ECU 10 to each of the TCU ECU 51 and the FCDIM ECU 16 via, respectively, the CO-CAN bus 13 and the PT-CAN bus 6. The processed data are visualised by the display of the IPC ECU 10 and the touch screen display of the FCDIM ECU 16. The TCU ECU 51 comprises a global positioning system (GPS) box for transmitting the processed data to remote receivers such as smartphones. A mobile phone network (not shown) is used. It should also be noted that in the configuration of FIGS. 5 to 7, the IPC ECU 10 hosts a look-up table of historic data of fuel consumption which are therefore passed to both the TCU ECU 51 and the FCDIM ECU 16 together with the (live) processed data.

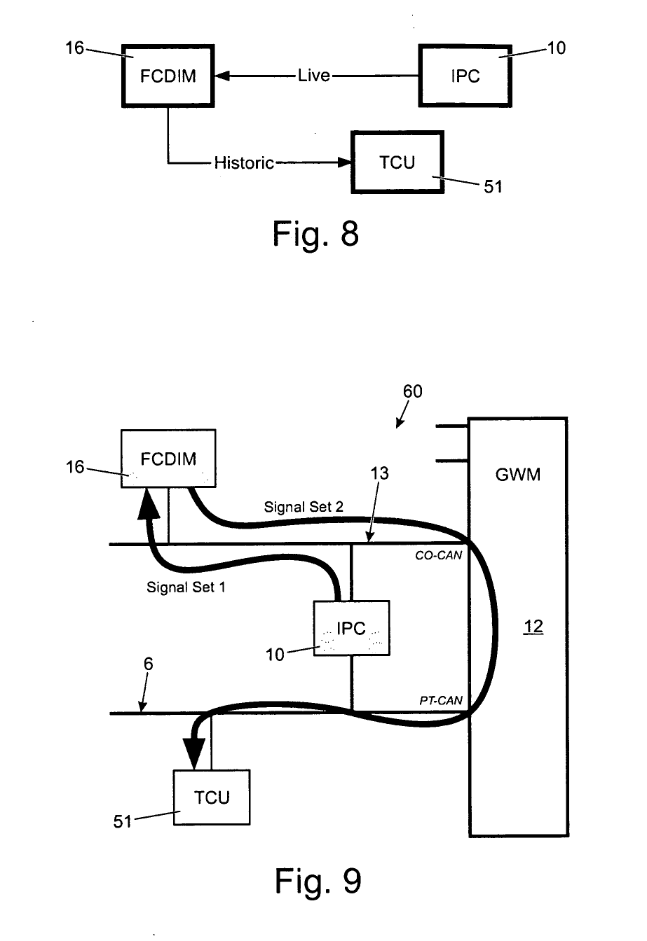

FIGS. 8 and 9 show an alternative system architecture 60 to that shown in FIGS. 5 to 7. The system architecture 60 is in accordance with an embodiment of the invention. This network architecture is not an embodiment of the invention, and is herein described purely to help the skilled person to appreciate the features of the invention by contrast. In FIGS. 8 and 9, the (live) processed data are sent from the IPC ECU 10 to the FCDIM ECU 16 which hosts the look-up table of the historic data. Combined historic and live processed data are then sent from the FDCIM ECU 16 to the TCU ECU 51 via the GWM ECU 12. FIG. 9 shows the data flow graphically superimposed to the diagram shown in FIG. 5. The GWM ECU 12 is responsible for transferring data from the CO-CAN bus 13 to the PT-CAN 6. The data displayed on the display of the IPC ECU 10 and on the touch screen of the FCDIM ECU 16 can potentially be different, but this is only because the latencies of the displays are not aligned. The displayed data are still centrally calculated by the IPC ECU 10.

### Lane Departure Warning System

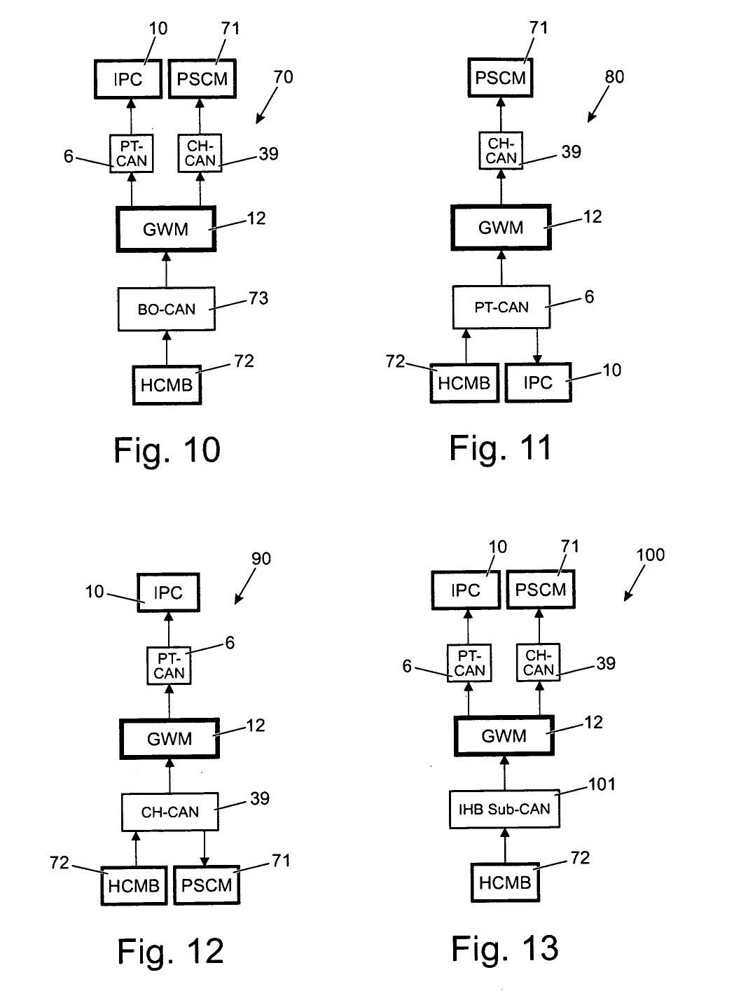

The network architecture of lane departure warning systems 70, 100 in accordance with embodiments of the present invention will now be described, in simplified terms, in connection with FIGS. 10 and 13. The network architectures represented in FIGS. 11 and 12 are not in accordance with the invention, and are herein described purely to help the skilled person to appreciate the features of the invention by contrast. Like reference numerals have been used to indicate features or components equivalent to features or components shown in FIG. 2, 3, 4, and/or 5 to 9.

FIG. 10 shows a lane departure warning system 70 comprising a vehicle camera (HCMB) ECU 72, a gateway module (GWM) ECU 12, an IPC ECU 10 and a power steering control module (PSCM) ECU 71. The vehicle headlamp camera module controls the height of the lights of the vehicle when an incoming vehicle is detected by a camera incorporated in the HCMB ECU 72. The HCMB ECU 72 and the GMW ECU 12 are in communication over a Body CAN (BO-CAN) bus 73. The HCMB ECU 72 is the nominated ECU, i.e. the ECU predisposed for central computation of to-be-displayed data. The GWM ECU 12 publishes the processed data on each of two data transmission buses, namely a PT-CAN 6 and a CH-CAN 39. The IPC ECU 10 subscribes to data from the PT-CAN 6, and the PSCM ECU 71 subscribes to data from the CH-CAN 39. Thus the HCMB ECU 72 collects raw data relating to relative positioning of the vehicle in a road lane, publishes them on the BO-CAN bus 73 for retrieval from the GWM ECU 12. The GWM ECU 12 publishes processed gateway data on the PT-CAN bus 6 and on the CH-CAN bus 39 for retrieval respectively from the IPC ECU 10 and the PSCM ECU 71 for output to the driver. The IPC ECU 10 outputs the processed data on a display in the form of a visual warning signal. Further, the IPC ECU 10 has the ability to cause a warning sound to be emitted simultaneously on a speaker (not shown) which is also part of the IPC ECU 10. The PSCM ECU 71 comprises a device for generating vibration on the steering wheel of the vehicle and is thus configured to output the processed data in the form of a haptic feedback signal.

FIG. 11 shows a lane departure warning system 80 according to an embodiment of the invention comprising a vehicle camera (HCMB) ECU 72, a gateway module (GWM) ECU 12, an IPC ECU 10 and a power steering control module (PSCM) ECU 71. The HCMB ECU 72 and the GMW ECU 12 are in communication over a PT-CAN bus 6. The ECU entrusted with processing the data is the HCMB ECU 72. Therefore, a single, nominated processing ECU is defined over this system architecture. The GWM ECU 12 publishes the data processed by the HCMB ECU 72 data to a CH-CAN bus 39. The IPC ECU 10 subscribes to data from the PT-CAN bus 6, and the PSCM ECU 71 subscribes to data from the CH-CAN bus 39. Thus the HCMB ECU 72 collects raw data relating to relative positioning of the vehicle and a road lane, publishes them on the PT-CAN bus 6 for retrieval from the GWM ECU 12. The GWM ECU 12 publishes processed data on the CH-CAN bus 39 for retrieval from the PSCM ECU 71 for output to the driver. The IPC ECU 10 outputs the processed data on a display in the form of a visual warning signal. The PSCM ECU 71 comprises a device for generating vibration on the steering wheel of the vehicle and is thus configured to output the processed data in the form of a haptic feedback signal. FIG. 11 shows a system 80 having latency differences between visual and haptic warnings. In this respect, the system 80 is similar to the system 90 of FIG. 12. FIGS. 10 and 13 do not have such latency differences due to the different distribution and strategy of ECUs onto the network. All solutions however prescribe the definition of a nominated ECU for performing the required calculations.

FIG. 12 shows a lane departure warning system 90 according to an embodiment of the invention comprising a vehicle camera (HCMB) ECU 72 a gateway module (GWM) ECU 12, an IPC ECU 10 and a power steering control module (PSCM) ECU 71. The HCMB ECU 72 and the GMW ECU 12 are in communication over a CH-CAN bus 39. The ECUs entrusted with processing the data is the HCMB ECU 72. Therefore a single, nominated processing ECU is defined over this system architecture. The GWM ECU 12 publishes the processed data to a PT-CAN bus 6. The IPC ECU 10 subscribes to data from the PT-CAN bus 6, and the PSCM ECU 71 subscribes to data from the CH-CAN bus 39. Thus the HCMB ECU 72 collects raw data relating to relative positioning of the vehicle and a road lane, publishes them on the CH-CAN bus 39 for retrieval from the GWM ECU 12. The GWM ECU 12 publishes processed data on the PT-CAN bus 6 for retrieval from the IPC ECU 10 for output to the driver. The IPC ECU 10 outputs the processed data on a display in the form of a visual warning signal. The PSCM ECU 71 comprises a device for generating vibration on the steering wheel of the vehicle and is thus configured to output the processed data in the form of a haptic feedback signal. The arrangement shown in FIG. 12 is very similar to that shown in FIG. 11, except for the fact that the relative positions in the network architecture of the PT-CAN bus 6 and of the CH-CAN bus 39 are inverted.

FIG. 13 shows a lane departure warning system 100 according to an embodiment of the invention comprising a vehicle camera (HCMB) ECU 72, a gateway module (GWM) ECU 12, an IPC ECU 10 and a power steering control module (PSCM) ECU 71. The HCMB ECU 72 and the GMW ECU 12 are in communication over an Intelligent High Beam (IHB) Sub-CAN bus 101. The GWM ECU 12 is the nominated ECU, i.e. the ECU predisposed for central computation of to-be-displayed data. The GWM ECU 12 publishes the processed data on each of two data transmission buses, namely a PT-CAN 6 and a CH-CAN 39. The IPC ECU 10 subscribes to data from the PT-CAN 6, and the PSCM ECU 71 subscribes to data from the CH-CAN 39. Thus the HCMB ECU 72 collects raw data relating to relative positioning of the vehicle and a road lane, publishes them on the IHB Sub-CAN bus 101 for retrieval from the GWM ECU 12. The GWM ECU 12 publishes processed data on the PT-CAN bus 6 and on the CH-CAN bus 39 for retrieval respectively from the IPC ECU 10 and the PSCM ECU 71 for output to the driver. The IPC ECU 10 outputs the processed data on a display in the form of a visual warning signal. The PSCM ECU comprises a device for generating vibration on the steering wheel of the vehicle and is thus configured to output the processed data in the form of a haptic feedback signal.

In each of the network architectures shown in FIGS. 10 and 13, the driver experiences consistency between the warning signals generated on the one hand by the display of the IPC ECU 10 and on the other hand by the vibration device of the PSCM ECU 71, i.e. the warning signals are generated without appreciable delay between each other.

Further aspects of the present invention are set out in the following numbered paragraphs:

1. A vehicle distributed network subsystem for providing feedback to a user, the subsystem comprising:
a plurality of electronic control units (ECUs); and
a data transmission network over which said ECUs can communicate with one another, the data transmission network being configured to receive data from at least one data source;
wherein the subsystem is configured to define a nominated ECU for generating processed data from the data received from said data transmission network, and
wherein the subsystem is configured to broadcast said processed data for delivery to two or more terminals for providing feedback to the user.

2. A vehicle distributed network subsystem according to paragraph 1, further comprising two or more terminals communicating with said ECUs over said data transmission network, wherein the subsystem is configured to deliver said processed data to each of said terminals for providing feedback to the user.

3. A vehicle distributed network subsystem according to paragraph 2, wherein the subsystem is configured to deliver said processed data to each of said terminals for substantially simultaneous output to the user.

4. A vehicle distributed network subsystem according to paragraph 3, wherein each of the two or more terminals is programmed to associate a data latency to the processed data, wherein each of said data latencies is below a predetermined value.

5. A vehicle distributed network subsystem according to paragraph 1, wherein the terminals are configured to output feedback to a vehicle occupant.

6. A vehicle distributed network subsystem according to paragraph 1, wherein the data transmission network is configured to receive data relating to an operating parameter of the vehicle.

7. A vehicle distributed network subsystem according to paragraph 1, wherein each of said terminals is part of a respective user interface ECU.

8. A vehicle distributed network subsystem according to paragraph 7, wherein a first of said user interface ECUs is configured to subscribe to a second of said user interface ECUs.

9. A vehicle distributed network subsystem according to paragraph 7, wherein a first and a second of said user interface ECUs are configured to subscribe to the nominated ECU.

10. A vehicle driver information system comprising a vehicle distributed network subsystem according to paragraph 2, wherein the data transmission network is configured to receive data from at least one of the following ECUs:
a powertrain control module (PCM) ECU;
a cruise control module (CCM) ECU;
a transmission control module (TCM) ECU;
a transfer case control module (TCCM) ECU;
an antilock braking system module (ABS) ECU; or
a parking aid module (PAM) ECU,
wherein an instrument panel cluster (IPC) ECU is configured to function as the nominated ECU, and
wherein each of the terminals is a display.

11. A vehicle driver information system according to paragraph 10, wherein a display is part of the IPC ECU.

12. A vehicle driver information system according to paragraph 10, wherein a display is part of a head-up display (HUD) ECU.

13. A vehicle driver information system according to paragraph 10, wherein the data transmission network is configured to receive data relating to vehicle or engine speed, the nominated ECU is configured to generate processed data relating to vehicle or engine speed, and the displays are each configured to visualise said processed data.

14. A vehicle wade sensing system comprising a vehicle distributed network subsystem according to paragraph 2, comprising a plurality of data transmission networks and a gateway module (GWM) ECU for distributing data between the data transmission networks, wherein at least one of said networks is configured to receive data from at least one of the following ECUs:
an anti-lock braking system (ABS) ECU;
a parking aid module (PAMB) ECU;
a forward or rearward park assist sensor;
a water presence sensor;
a water depth sensor; or
a chassis control module (CHCM),
wherein the PAMB ECU is configured to function as the nominated ECU, and
wherein each of the terminals is a display.

15. A vehicle wade sensing system according to paragraph 14, wherein one of the displays is part of an instrument panel cluster (IPC) ECU.

16. A vehicle wade sensing system according to paragraph 15, wherein another one of the displays is part of a front control display interface module (FCDIM) ECU.

17. A vehicle wade sensing system according to paragraph 16, wherein at least one of the data transmission networks is configured to receive data relating to a level of water surrounding the vehicle, the nominated ECU is configured to generate processed data relating to said level of water, and the displays are each configured to visualise said processed data.

18. A vehicle eco-driving system comprising a vehicle distributed network subsystem according to paragraph 2, comprising a plurality of data transmission networks and a gateway module (GWM) ECU for distributing data between the data transmission networks,
wherein at least one of said data transmission networks is configured to receive data relating to fuel consumption,
wherein an instrument panel cluster (IPC) ECU is configured to function as the nominated ECU, and
wherein each of the terminals is a display.

19. A vehicle eco-driving system according to paragraph 18, wherein one of the displays is part of the IPC ECU.

20. A vehicle eco-driving system according to paragraph 19, wherein another one of the displays is part of a front control display interface module (FCDIM) ECU.

21. A vehicle eco-driving system according to paragraph 18, wherein the nominated ECU is configured to generate processed data relating to fuel consumption, and the displays are each configured to visualise a signal for encouraging eco-driving based on said processed data.

22. A vehicle lane departure warning system comprising a vehicle distributed network subsystem according to paragraph 2, comprising a plurality of data transmission networks and a gateway module (GWM) ECU for distributing data between the data transmission networks,
wherein at least one of said networks is configured to receive data relating to relative positioning of the vehicle in a lane,
wherein a vehicle camera module ECU is configured to function as the nominated ECU, and
wherein at least one of the terminals is a display.

23. A vehicle lane departure warning system according to paragraph 22 wherein the at least one terminal comprising the display is part of an instrument panel cluster (IPC) ECU.

24. A vehicle lane departure warning system paragraph 22, wherein at least one of the terminals is a haptic feedback terminal for providing haptic feedback to the vehicle occupant.

25. A vehicle lane departure warning system according to paragraph 24, wherein the haptic feedback terminal is part of a power steering control module (PSCM) ECU.

26. A vehicle lane departure warning system according to paragraph 22, wherein said at least one of said data transmission networks is configured to receive data from a vehicle camera.

27. A vehicle distributed network comprising a vehicle distributed network subsystem according to paragraph 1, and/or a vehicle driver information system according to paragraph 10, and/or a vehicle wade sensing system according to paragraph 14, and/or a vehicle eco driving system according to paragraph 18, and/or a vehicle lane departure warning system according to paragraph 22.

28. A vehicle comprising a vehicle distributed network according to paragraph 27.

29. A method of providing feedback to a user of a vehicle on a plurality of terminals connected to a vehicle distributed network, the method comprising:
supplying data over a data transmission network connected to a plurality of electronic control units (ECUs);
processing said data by means of a nominated ECU in order to generate a set of processed data; and
broadcasting the processed data for delivery to said terminals for output to the user.

30. A distributed computer program product for configuring or reconfiguring a vehicle distributed network, the computer program product comprising a computer readable storage medium including computer readable program code, wherein the computer readable program code when executed on a vehicle system comprising a vehicle distributed network configures the vehicle distributed network for performing a method according to paragraph 29.

31. A distributed computer program product for configuring or reconfiguring a vehicle distributed network, the computer program product comprising a computer readable storage medium including computer readable program code, wherein the computer readable program code when executed on a vehicle system comprising a vehicle distributed network configures or reconfigures the vehicle distributed network such that any one or more of: a vehicle distributed network subsystem according to paragraph 1; a vehicle driver information system according to paragraph 10; a vehicle wade sensing system according to paragraph 14; a vehicle eco driving system according to paragraph 18; and/or a vehicle lane departure warning system according to paragraph 22 can be identified.

1. A vehicle distributed network subsystem for providing feedback to a user, the subsystem comprising:
a plurality of electronic control units (ECUs); and
a data transmission bus over which the ECUs can communicate with one another, the data transmission bus configured to receive data from at least one data source;
wherein the subsystem is configured to define a nominated ECU for generating processed data from the data received from the data transmission bus, and
wherein the subsystem is configured to broadcast the processed data for delivery to two or more terminals for providing feedback to the user.

2. The vehicle distributed network subsystem of claim 1, wherein the data transmission bus is configured to receive data relating to an operating parameter of the vehicle.

3. The vehicle distributed network subsystem of claim 1, further comprising two or more terminals communicating with the ECUs, wherein the subsystem is configured to deliver the processed data to each of the terminals for providing feedback to the user.

4. The vehicle distributed network subsystem of claim 3, wherein the subsystem is configured to deliver the processed data to each of the terminals for substantially simultaneous output to the user.

5. The vehicle distributed network subsystem of claim 4, wherein each of the two or more terminals is programmed to associate a respective data latency to the processed data, wherein each respective data latency is below a predetermined value.

6. The vehicle distributed network subsystem of claim 3, wherein the terminals are configured to output feedback to a vehicle occupant.

7. The vehicle distributed network subsystem of claim 3, wherein each of the terminals is part of a respective user interface ECU.

8. The vehicle distributed network subsystem of claim 7, wherein a first of the user interface ECUs is configured to subscribe to a second of the user interface ECUs, or the first and the second of the user interface ECUs are configured to subscribe to the nominated ECU.

9. (canceled)

10. A vehicle driver information system comprising the vehicle distributed network subsystem of claims 3, wherein the data transmission bus is configured to receive data from at least one of the following ECUs:
a powertrain control module (PCM) ECU;
a cruise control module (CCM) ECU;
a transmission control module (TCM) ECU;
a transfer case control module (TCCM) ECU;
an antilock braking system module (ABS) ECU; or
a parking aid module (PAM) ECU,
wherein an instrument panel cluster (IPC) ECU is configured to function as the nominated ECU, and
wherein each of the terminals is a display.

11-12. (canceled)

13. The vehicle driver information system of claim 10, wherein the data transmission bus is configured to receive data relating to vehicle or engine speed, the nominated ECU is configured to generate processed data relating to vehicle or engine speed, and the displays are each configured to visualize the processed data.

14. A vehicle wade sensing system comprising the vehicle distributed network subsystem of claims 3, comprising a plurality of data transmission busses and a gateway module (GWM) ECU for distributing data between the data transmission busses, wherein at least one of the data transmission busses is configured to receive data from at least one of the following ECUs:
an anti-lock braking system (ABS) ECU;
a parking aid module (PAMB) ECU;
a forward or rearward park assist sensor;
a water presence sensor;
a water depth sensor; or
a chassis control module (CHCM),
wherein the PAMB ECU is configured to function as the nominated ECU, and
wherein each of the terminals is a display.

15-16. (canceled)

17. The vehicle wade sensing system of claim 1, wherein at least one of the data transmission busses is configured to receive data relating to a level of water surrounding the vehicle, wherein the nominated ECU is configured to generate processed data relating to the level of water, and wherein the displays are each configured to visualize the processed data.

18. A vehicle eco-driving system comprising the vehicle distributed network subsystem of claim 3, comprising a plurality of data transmission busses and a gateway module (GWM) ECU for distributing data between the data transmission busses,
wherein at least one of the data transmission busses is configured to receive data relating to fuel consumption,
wherein an instrument panel cluster (IPC) ECU is configured to function as the nominated ECU, and
wherein each of the terminals is a display.

19-20. (canceled)

21. The vehicle eco-driving system of claim 18, wherein the nominated ECU is configured to generate processed data relating to fuel consumption, and wherein the displays are each configured to visualize a signal for encouraging eco-driving based on the processed data.

22. A vehicle lane departure warning system comprising the vehicle distributed network subsystem of claim 3, comprising a plurality of data transmission busses and a gateway module (GWM) ECU for distributing data between the data transmission busses,
wherein at least one of the data transmission busses is configured to receive data relating to relative positioning of the vehicle in a lane,
wherein a vehicle camera module ECU is configured to function as the nominated ECU, and
wherein at least one of the terminals is a display.

23. The vehicle lane departure warning system of claim 22, wherein the at least one terminal comprising the display is part of an instrument panel cluster (IPC) ECU and/or wherein at least one of the terminals is a haptic feedback terminal for providing haptic feedback to the vehicle occupant.

24-25. (canceled)

26. The vehicle lane departure warning system of claim 22, wherein the at least one of the data transmission busses is configured to receive data from a vehicle camera.

27. (canceled)

28. A vehicle comprising the vehicle distributed network of claim 1.

29. A method of providing feedback to a user of a vehicle on a plurality of terminals connected to a vehicle distributed network, the method comprising:
supplying data to a data transmission bus connected to a plurality of electronic control units (ECUs);
processing the said data via a nominated ECU in order to generate a set of processed data; and
broadcasting the processed data for delivery to the terminals for output to the user.

30. A distributed computer program product for configuring or reconfiguring a vehicle distributed network, the computer program product comprising a computer readable storage medium including computer readable program code, wherein the computer readable program cod; when executed on a vehicle system comprising a vehicle distributed network configures the vehicle distributed network for performing the method of claim 29.

31-35. (canceled)
